(19) United States
(12) Patent Application Publication
(10) Pub. No.: US 2013/0063766 A1
(43) Pub. Date: Mar. 14, 2013

(54) PAGE COMPLEXITY ANALYZER

(71) Applicants: Doniel M. Lax, Modiin (IL); Leonid Khain, Herzliya (IL)

(72) Inventors: Doniel M. Lax, Modiin (IL); Leonid Khain, Herzliya (IL)

(21) Appl. No.: 13/230,034

(22) Filed: Sep. 12, 2011

(51) Int. Cl. G06K 15/02

(52) U.S. Cl. 358/1.15

(57) ABSTRACT

A method for estimating complexity of pages and controlling printing speed of a printing machine wherein the speed is set according to the estimated complexity of pages, the method includes the steps of processing pages elements; storing the processed pages elements in an input memory; estimating complexity of pages assembly according to the processed elements of pages in the estimated pages; assembling the pages from the elements of pages comprised in the estimated pages to produce ready to print pages; transmitting the ready to print pages to a print engine for printing; and setting the print engine speed wherein the speed is selected according to the estimated complexity of pages assembly.

### CROSS REFERENCE TO RELATED APPLICATIONS

Reference is made to commonly-assigned copending U.S. patent application Ser. No. ______ (Attorney Docket No. K000543US01NAB), filed herewith, entitled PAGE COMPLEXITY ANALYZER, by Lax; the disclosure of which is incorporated herein.

### FIELD OF THE INVENTION

The present invention relates to high speed variable data printing systems and, more particularly, to assuring the supply of sufficient data to the print engine of a high speed printing system so the engine can operate continuously and efficiently.

### BACKGROUND OF THE INVENTION

High speed printing systems must assure the supply of sufficient data to the print engine so that the engine can run without stopping since it is impractical to stop and start the printer in a short period of time. Typically, the system is designed to run at full rate for most documents. However, a certain document may have very complex pages that when processing them the system will not be capable of providing the data at full rate. The complexity of a page originates from ripping raster image processing (RIP) complexity which for page description languages (PDL) such as Postscript is highly data dependent and may consume considerable amount of time for page processing. Most printers buffer a small number of rasterized pages in memory to help smooth the data stream to the printer. This may ease short or erratic increases in page complexity, but cannot solve the problem for long sequences of complex pages. In this case the printer must be slowed down in order to accommodate for the increase in complexity.

A solution to the problem is described in the U.S. Pat. No. 6,762,855 (Goldberg et al.), which suggests using a large image buffer memory for holding completely processed images (previously rasterized) in combination with an intelligent control system. The raster image processed pages can be stored in a compressed form to increase capacity of storage. This enables the system to accumulate slack time that is left over from raster image processing of non-complex pages, and allocate it to complex pages so speed of printing is optimized with average ripping time. This accommodates situations where, on average, the complexity of pages and the system bandwidth are comparable, but may be overtaxed for some periods. The printer controller uses information from the buffer manager to control the speed of the transport, so that the speed of consuming image buffers is matched to the speed of ripping the pages. The printer controller continually inspects the backlog of pages in the buffer memory. If the backlog of pages grows, the printer controller instructs the transport to increase the web speed. If the backlog of completed pages fills the memory buffers (or some other predefined amount of pages is reached), the speed is increased to maximum web speed. However, if the backlog of completed pages decreases, the controller assumes that the amount of processing is such that the printer cannot maintain the current web speed. Hence it will ramp the transport down to maintain the queue at a steady point.

The invention described below uses a digital front end (DFE) architecture at which a job is ripped (rasterized) and stored in a ready to print (RTP) format on disk during the process stage. The processing can be done offline if desired. The RTP format is highly structured and therefore the complexity of an RTP format page can be predicted more precisely than a page which is described by a PDL language.

### SUMMARY OF THE INVENTION

Briefly, according to one aspect of the present invention a method for estimating complexity of pages and controlling printing speed of a printing machine wherein the speed is set according to the estimated complexity of pages, the method includes the steps of processing pages elements; storing the processed pages elements in an input memory; estimating complexity of pages assembly according to the processed elements of pages in the estimated pages; assembling the pages from the elements of pages comprised in the estimated pages to produce ready to print pages; transmitting the ready to print pages to a print engine for printing; and setting the print engine speed wherein the speed is selected according to the estimated complexity of pages assembly.

The invention and its objects and advantages will become more apparent in the detailed description of the preferred embodiment presented below.

### BRIEF DESCRIPTION OF THE DRAWINGS

FIG. 1 is schematic system architecture structure of print controller feeding data to print engine;

FIG. 2 is a diagrammatic scheme of the processing print station;

FIG. 3 is a diagrammatic scheme of the data merger;

FIG. 4A is a diagram of series of blocks with calculated block percent and selected speed for the block perfect;

FIG. 4B is a diagram of series of blocks with calculated block percent and selected speed for the block perfect;

FIG. 5A is a diagram of series of blocks in a partially populated input memory with calculated block percent and selected speed for the block perfect; and

FIG. 5B is a diagram of series of blocks in a partially populated input memory with calculated block percent and selected speed for the block perfect.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

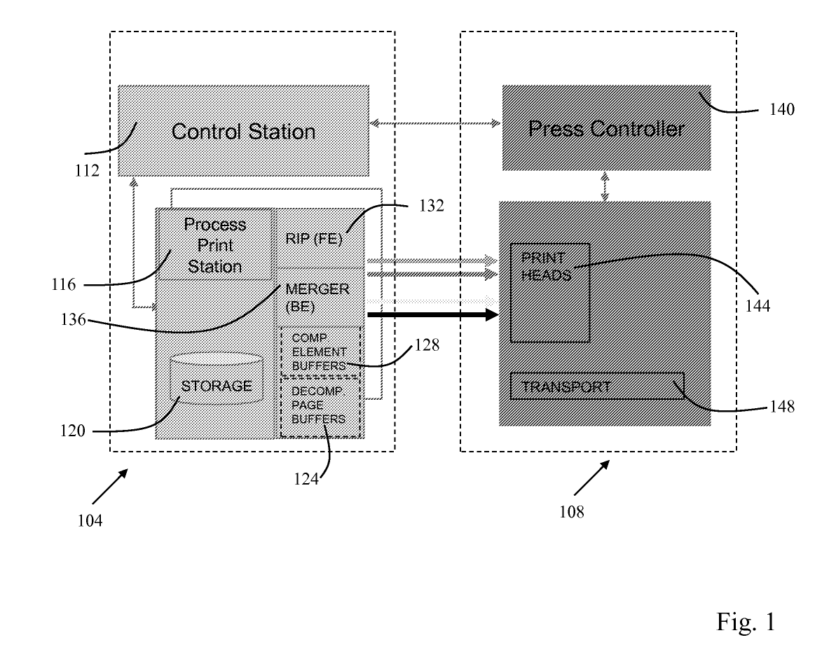

FIG. 1 shows the system architecture used by the disclosed invention in a schematic structure. Print controller 104 feeds data to print engine 108 for printing at a rated print engine speed.

Print controller 104 includes a control station 112 configured to control data feeding sequence to print engine 108, to be coordinated with press controller 140. Processing print station 116 receives digital print job for processing. The processing of the print jobs is performed by RIP element 132. The print jobs are ripped (rasterized) into an RTP format and stored on disk storage 120 during the processing stage. The processing can be done offline if desired. While printing, the RTP is read from storage 120 into dedicated hardware elements (124, 128, 136) which prepare and send the processed pages to print heads 144 to be printed using transport element 148.

The RTP format is a highly efficient format which contains both fixed and variable elements in a compressed format. The ripping of a fixed element is performed only once per job, thus saving processing time and a single copy is stored per job, thus saving storage space. This is a huge advantage in common VDP (variable data printing) jobs, where many pages share the same master background and the unique variable information is only a small part of the page.

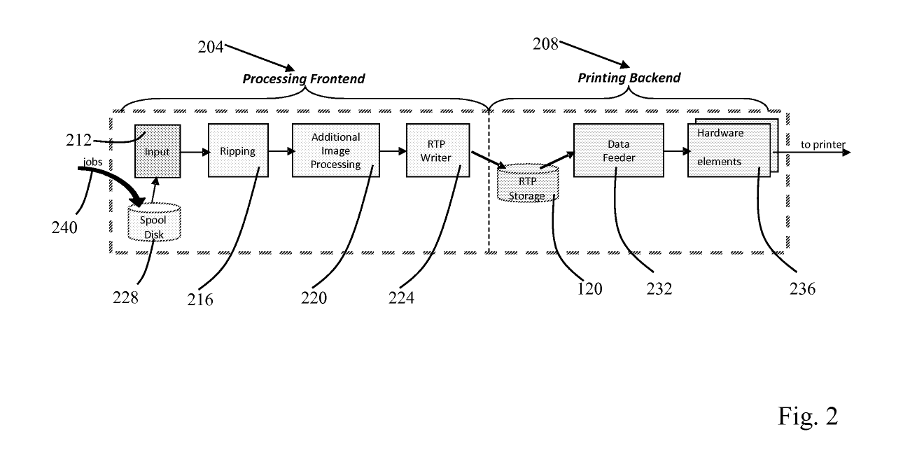

FIG. 2 shows a diagrammatic illustration of the processing print station 116. During the processing frontend stage 204, the incoming print jobs 240 are spooled into spool disk 228. The input element 212 receives print jobs 240 from spool disk 228. The print jobs 240 are further rasterized by the ripping stage 216. Additional processing steps 220 are performed on the rasterized data typically for color processing and other algorithms to repair possible artifacts during printing. The final processed job is written by RTP writer 224 to storage 120.

During the backend processing stage 208, the RTP data is read from storage 120 by the data feeder 232. The RTP data and related elements are further provided to hardware elements 236, to be assembled and delivered to the printer for printing.

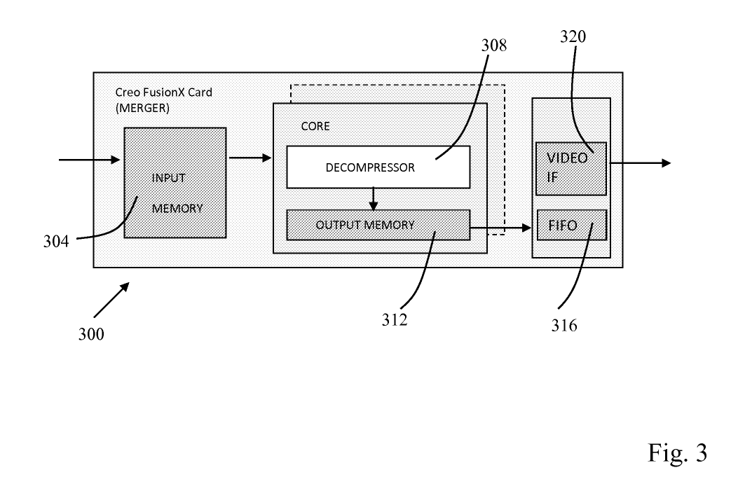

During the printing stage as is shown in FIG. 3, the compressed elements are loaded from storage 120 into input memory 304, which is a large image buffer holding compressed data. The stored compressed data (in a form of RTP) may contain information representing several hundred of pages. The elements are decompressed by decompressor 308 and the page is assembled into the output memory 312 and is passed to a first in first out (FIFO) buffer 316 which can hold few dozens of fully assembled pages. The assembled pages are further delivered to the printer via the video interface 320.

Similarly to the cited prior art U.S. Pat. No. 6,762,855, input memory 304 is a large raster image buffer of processed elements that can be used to resolve the ripping time complexity which is inherently undetermined. Although this invention does not use complete raster image processed pages, by the available page layout a determination is made for each page whether all element required for page assembly are loaded into input memory 304. Monitoring the amount of pages that are loaded into input memory 304 also resolves the issue of the time it takes to read elements from storage 120.

The accumulation of elements in the input memory 304 cannot simply be used to control the print speed as there are additional sources of complexity which arise from the fact that the pages are not fully assembled and these complexities are not resolved yet. Pages with many elements or with several very large elements may be complex pages since they have an ‘area coverage’ (i.e. total number of pixels) that is greater than what the system was designed for. Additionally, total compressed size of all elements may be very large, requiring more bandwidth than designed for. Hence, although merger 300 hardware is designed to handle complex pages, i.e. pages with high area coverage or with high bandwidth requirements (low compression ratio), there may always be a case which exceeds the design. In these extreme and rare cases a problem may still arise, which will require to ramp down the printer speed. The relatively small FIFO 316 does not enable to use its backlog information for controlling the printing speed there is not enough time to slow down the printer gradually. Moreover, it introduces an acute problem of ensuring that the small FIFO 316 does not empty out during printing due to a sequence of very complex pages.

Fortunately, opposed to ripping time, the time required for decompression and page assembly can be estimated and an upper bound and can be determined from several simple parameters of the elements that make up a page. As stated above, the system was designed to handle a certain level of complexity. Pages that stand within the designed complexity will be set to complexity level of 1, and will be counted as one ready page. Pages that exceed the designed complexity will be set to complexity level greater than 1, and will be counted as less than a ready page. A detailed description of RTP page complexity calculation is given below. This information is used to control the press speed in a manner that will be described in the following sections, thus enabling the smooth printing of complex jobs and RTP pages.

A fundamental assumption is that the merger is designed and tuned to handle must jobs at full printer speed. That is, cases of pages with complexity greater than 1 are uncommon and sporadic. The chance for a sequence of complex pages, i.e. pages with complexity greater than 1, is very low. Hence, the cases that requires the printer to slow down due to page assembly complexity are rare. This enables a stricter but simpler approach to be taken and handle the worst case situation as this does not happen often. For instance, although some pages may principally have a complexity that is less than 1, which could be theoretically used to compensate for pages with complexity greater than 1, a strict but simplified approach is taken and set the minimal complexity to 1.

The goal is to ensure that the FIFO buffer 316 never empties out. The basic idea is to look ahead and analyze the complexity of a block of pages, rather than a single page, and adjust the printer's speed so that it prints the block at a speed that is appropriate to the block's complexity. For example, a block that has a calculated complexity that is twice the normal complexity will be printed at a printer speed that is half the full speed, as the overall maximum time required to prepare and assemble the pages may be up to twice the time required for a normal page. This guarantees that the backlog of pages in the FIFO 316 does not decrease while printing the block of pages. Assuming the FIFO buffer 316 was full before the print started, it should remain full at the end of printing each block regardless of its complexity.

The block size is chosen as a fraction of the FIFO buffer 316 capacity, typically around half the size (5-10 pages). On one hand, this gives a high enough resolution of the complexity to manage the printer's speed, and on the other hand it is a large enough block to relax the influence of sporadic complex pages.

For each block a block percent is calculated. The calculated block percent represents an average of the page percent of the pages in the block. The page percent is the reciprocal of the page complexity as defined in page complexity explanation below. For example a block percent 100 indicates that the pages in the block can be printed at machine maximal speed, whereas block percent 50 indicates that the pages in the block are more complicated and therefore may require lowering the speed of the printer for effective printing.

The block percent gives the maximal percent of the full speed at which the block can be printed. Furthermore, a linked list of block percents for all pages that are loaded into the input memory 304, is constructed. By analyzing the list of block percents, the printer controller can determine the actual printing speed per block that does not exceed the maximal printing speed calculated by the page complexity on one side and on the other side stands with in the transports acceleration capabilities with smooth changes.

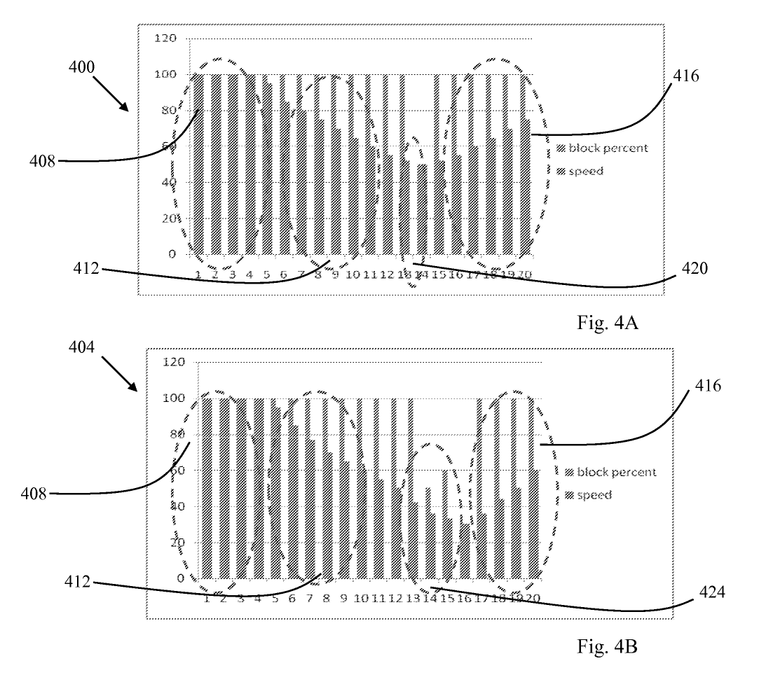

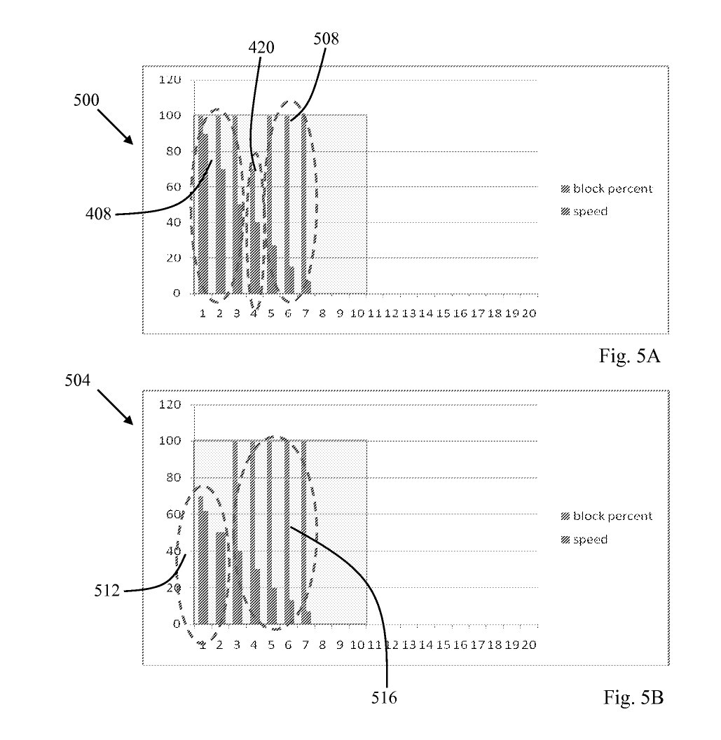

FIGS. 4A, 4B, 5A and 5B show the resulted block percent and its impact of printer speed. Block percent versus speed 400, 404, 500 and 504 are shown in these figures. Each pair represents a block percent for the block and the desired printer speed required to print each block.

In FIG. 4A, the pairs indicated by numeral 408 show blocks that will be printed at full machine speed. Pairs 412 although can be printed at full rated speed will be printed at a reduced speed because the blocks that will follow them 420 are found to be complicated, hence require printing speed reduction. In order to reach the required speed for blocks 420 the printing speed for blocks at 412 should be gradually reduced to comply with printer's characteristics for speed change. Also the blocks in 416 although can be printed at full speed will gain speed gradually following printing the complicated blocks 420.

FIG. 4B shows a similar situation to the one shown in FIG. 4A. It shows few successive blocks 424 with reduced speed capability, found in input memory 304.

By setting a minimal amount of ready blocks required for full printing speed (e.g. 10 blocks), the printer controller will ramp down the speed when the list of ready block drops below this threshold. The printer controller will set the printing speed to the minimum between the speed dictated by the complexity and the speed that matches the rate of the emptying out page buffer as is shown in FIGS. 5A and 5B. FIG. 5A shows input memory 304 with three different blocks. Starting with full speed capable blocks 408, speed is reduced to comply with a slow block 420 following 408. Blocks 508 are the last in the input memory 304 in this example. Although blocks 508 are capable to be printed at full speed, the speed is highly reduced to comply with gradual speed change in the printing device as well as with the accelerated data depletion from input memory 304. FIG. 5B shows a similar example to the one shown in FIG. 5A. Here two block series are shown, starting with 512, comprising from low block percent, thus mandating speed reduction. Blocks 512 are followed with blocks 516. Again, blocks 516 are capable for full speed printing, require high speed reduction to both comply with the gradual speed reduction of the printer and the accelerated data depletion from input memory 304.

The page complexity calculation is explained below. The system is designed to handle a certain level of “complexity”, generally overall 8:1 compression ratio (CR_{D}=8) and 300% coverage (CV_{D}=300). Hence, pages that are within this complexity are processed in real-time and do not require the slowing down of the print engine. Pages that are more complex will require more processing time and may require the slowing down of the print engine.

Pages that stand within the designed complexity will have a complexity of 1, and will be counted as one page. Pages that exceed the designed complexity will have a complexity greater than 1, and will counted as less than a page. The functions for calculating the complexity of a page and for deriving the percent of a page that is done are given below.

For each page a total compressed size (CS_{T}) is defined as the total size in bytes of all compressed elements that are going to be decompressed for the page.

$${CS}_{T} = {\sum }_{i = 1}^{N} {CS}_{i}$$

where N is the number of elements in a page and CSᵢ is the compressed size (in bytes) of element i.

For each page an effective decompressed size (DS_{E}) is defined. Generally, the decompressed size is the number of pixels that are written to memory during decompression of the page. However, DS_{E} accounts also for some overhead that exists in the system and consumes time that could have been used for writing more pixels. This is achieved by adding to DS_{E} an amount of pixels that their time of writing to memory corresponds to the time lost on overheads.

$${DS}_{E} = {\sum }_{i = 1}^{N} {DS}_{Ei}$$

Where N is the number of elements in a page and DS_{Ei} is the effective decompressed size of element i, and is given by the formula below:

DS_{Ei}=(x_{Ei}*yᵢ)+P_{INIT}

In order to determine DS_{Ei} its components are to be defined:
a. x_{Ei}—effective width of element i

x_{Ei}=MAX{xᵢ, BURSTₘᵢₙ}
where:
xᵢ—width of element i
BURSTₘᵢₙ—minimum number of pixels that must be written to a memory line (typically 256)
yᵢ—height of element i
b. P_{INITi}—number of pixels that ‘can’ be written during initialization time of element i

P_{INIT}=Tᵢₙᵢₜ·Freq·Factor
where:
Tᵢₙᵢₜ—initialization time of element
Freq—merger's clock frequency
Factor—number of pixels decoded per clock
   A page size (PS) is defined as the number of pixels in a page, i.e. page width multiplied by page height. Now, the actual compression ratio is defined as follows:

CR_{A}=PS/CS_{T},

and the actual coverage as:

CV_{A}=DS_{E}/PS·100.

The page complexity (PC) is defined as:

PC=MAX{CR_{D}/CR_{A}CV_{A}/CV_{D}, 1},

PC>=1

and the page percent (PP) is given by:

PP=1/PC*100

0%<PP<=100%

The invention has been described in detail with particular reference to certain preferred embodiments thereof, but it will be understood that variations and modifications can be effected within the scope of the invention.

### PARTS LIST

104 printer controller
108 print engine
112 control station
116 processing print station
120 storage
124 decompression page buffer
128 compression elements buffers
132 RIP
136 merger
140 press controller
144 print heads
148 transport element
204 frontend
208 backend
212 input
216 ripping
220 additional image processing steps
224 RTP writer
228 spool disk
232 data feeder
236 hardware elements
240 incoming print jobs
300 merger (assembly means)
304 input memory
308 decompressor
312 output memory
316 first in first out (FIFO)
320 video interface
400 block percent versus speed pairs diagram
404 block percent versus speed pairs diagram
408 full speed capable blocks
412 reduced speed for full speed capable blocks
416 elevated speed for full speed capable blocks
420 blocks with reduced speed capability
424 few blocks with reduced speed capability shown in succession
500 block percent versus speed pairs diagram
504 block percent versus speed pairs diagram
508 highly reduced speed for full speed capable blocks
512 blocks with reduced speed capability
516 highly reduced speed for full speed capable blocks

1. A method for estimating complexity of pages and controlling printing speed of a printing machine wherein the speed is set according to the estimated complexity of pages, the method comprising the steps of:
processing pages elements;
storing the processed pages elements in an input memory;
estimating complexity of pages assembly according to the processed elements of pages in the estimated pages;
assembling the pages from the elements of pages comprised in the estimated pages to produce ready to print pages;
transmitting the ready to print pages to a print engine for printing; and
setting the print engine speed wherein the speed is selected according to the estimated complexity of pages assembly.

2. The method according to claim 1 wherein speed of the print engine is variable.

3. The method according to claim 1 wherein the print engine speed is set by maximizing the speed of the print engine without depleting the pages in the input buffer.

4. The method according to claim 1 wherein the elements of pages are selected from a group comprising processed text and graphics, compressed images, processed variable elements, compressed variable elements or combinations thereof.
